(19) United States
(12) Patent Application Publication
(10) Pub. No.: US 2010/0208797 A1
(43) Pub. Date: Aug. 19, 2010

(54) DISTRIBUTED VIDEO ENCODER AND DECODER, AND DISTRIBUTED VIDEO ENCODING AND DECODING METHOD

(75) Inventors: Jung Won KANG, Daejeon (KR); Kyung Jun LEE, Daejeon (KR); Il Hong SHIN, Daejeon (KR); Jeong Ju YOO, Daejeon (KR); Jin Woo HONG, Daejeon (KR); Sang-Uk PARK, Seoul (KR); Jin Woo CHOI, Seoul (KR); Chang Su KIM, Seoul (KR); Sang Uk LEE, Seoul (KR)

Correspondence Address: LADAS & PARRY LLP, 224 SOUTH MICHIGAN AVENUE, SUITE 1600, CHICAGO, IL, 60604, US

(73) Assignees: Electronics and Telecommunications Research Institute, Daejeon (KR); SNU R&DB FOUNDATION, Seoul (KR)

(21) Appl. No.: 12/706,066

(22) Filed: Feb. 16, 2010

(30) Foreign Application Priority Data
Feb. 17, 2009 (KR) 10-2009-0012759

(51) Int. Cl. H04N 7/12

(52) U.S. Cl. 375/240.03; 375/240.25; 375/E07.027; 375/E07.076

(57) ABSTRACT

A distributed video encoder and decoder and a distributed video encoding and decoding method through a symmetrical motion prediction and channel division are provided. Side information may be generated through the symmetrical motion prediction, and only a portion, which is significantly distorted, may be encoded and decoded into a channel code through an evaluation of the side information and thus, a configuration of the distributed video decoder may be simplified.

### CROSS-REFERENCE TO RELATED APPLICATION

This application claims priority from Korean Patent Application No. 10-2009-0012759, filed on Feb. 17, 2009, in the Korean Intellectual Property Office, the entire disclosure of which is incorporated herein by reference.

### BACKGROUND OF THE INVENTION

1. Field of the Invention

The present invention relates to a distributed video encoder and decoder, and a distributed video encoding and decoding method through a symmetrical motion prediction and channel division.

2. Description of Related Art

In a conventional art, a video communication system is designed to enable a small number of service providers to provide a number of users with a video service such as with a Video On Demand (VOD) system. Accordingly, a configuration of an encoder may be complex, whereas a decoder may be relatively simply configured.

Thus, a low specification device such as a cellular phone and a Personal Digital Assistant (PDA) may not encode a high-resolution image in a system with a complex encoder.

Accordingly, researches on a Distributed Video Coding (DVC) scheme, which enables a simple encoder and a complex decoder to be configured instead of a complex encoder and a simple decoder, has been conducted.

### SUMMARY OF THE INVENTION

An aspect of the present invention provides a distributed video encoder and decoder, and a distributed video encoding and decoding method that may overcome a low coding efficiency of a Distributed Video Coding (DVC) system using a feedback channel and a channel code in terms of a bit rate-distortion, and overcome a high computation demand generated when a channel code is decoded.

Another aspect of the present invention also provides a distributed video encoder and decoder, and a distributed video encoding and decoding method that may reduce distortion of side information, and may remove a portion remaining when a channel code is decoded, and thereby may reduce computation.

Another aspect of the present invention also provides a distributed video encoder and decoder, and a distributed video encoding and decoding method that may generate side information through a symmetrical motion prediction, encode and decode only a portion, which is significantly distorted in the side information, through an evaluation of the side information, and thereby may relatively simplify a decoder.

According to an aspect of the present invention, there is provided a distributed video encoder, including: a key frame encoding unit to encode a key frame of a video and provide the encoded key frame to a distributed video decoder, the video including the key frame and a Wyner-Ziv frame; a buffer to receive first channel video information, which is distorted by more than a predetermined value, in response to the provided key frame, the first channel video information being divided from side video information generated by applying a video interpolation scheme to the key frames; a quantization unit to quantize the Wyner-Ziv frame using the first channel video information; and a Wyner-Ziv frame encoding unit to encode the quantized Wyner-Ziv frame.

The first channel video information may include blocks having a confidence less than a predetermined value.

According to an aspect of the present invention, there is provided a distributed video decoder, including: a key frame decoding unit to receive and decode an encoded key frame, the key frame being extracted from an input video; a side information generation unit to generate side video information used to decode a Wyner-Ziv frame by applying a video interpolation scheme to the key frames; and a division unit to divide the side video information into first channel video information and second channel video information, and to provide the first channel video information to a distributed video encoder, the first channel video information being distorted by more than a predetermined value, and the second channel video information being distorted by less than the predetermined value.

The distributed video decoder may further include a Wyner-Ziv frame decoding unit to decode the Wyner-Ziv frame, encoded using the first channel video information, using the second channel video information.

The distributed video decoder may further include a reconstruction unit to reconstruct the decoded Wyner-Ziv frame using the side video information.

The first channel video information may include blocks having a confidence less than a predetermined value.

The second channel video information may include blocks having a confidence greater than a predetermined value.

According to an aspect of the present invention, there is provided a distributed video encoding method, including: extracting a key frame and a Wyner-Ziv frame from an input video; encoding the key frame and providing the encoded key frame to a distributed video decoder; receiving first channel video information, which is distorted by more than a predetermined value, in response to the provided key frame, the first channel video information being divided from side video information generated by applying a video interpolation scheme to the key frames; quantizing the Wyner-Ziv frame using the first channel video information; and encoding the quantized Wyner-Ziv frame.

The first channel video information may include blocks having a confidence less than a predetermined value.

According to an aspect of the present invention, there is provided a distributed video decoding method, including: receiving and decoding an encoded key frame, the key frame being extracted from an input video; generating side video information used to decode a Wyner-Ziv frame by applying a video interpolation scheme to the key frames; and dividing the side video information into first channel video information and second channel video information, and providing the first channel video information to a distributed video encoder, the first channel video information being distorted by more than a predetermined value, and the second channel video information being distorted by less than the predetermined value.

The distributed video decoding method may further include decoding the Wyner-Ziv frame, encoded using the first channel video information, using the second channel video information.

The distributed video decoding method may further include reconstructing the decoded Wyner-Ziv frame using the side video information.

The first channel video information may include blocks having a confidence less than a predetermined value.

The second channel video information may include blocks having a confidence greater than a predetermined value.

According to the present invention, a distributed video encoder and decoder, and a distributed video encoding and decoding method may overcome a low coding efficiency of a Distributed Video Coding (DVC) system using a feedback channel and a channel code in terms of a bit rate-distortion, and overcome a high computation generated when a channel code is decoded.

Also, according to the present invention, a distributed video encoder and decoder, and a distributed video encoding and decoding method may reduce distortion of side information, remove portion remaining when a channel code is decoded, and thereby may reduce computation.

Also, according to the present invention, a distributed video encoder and decoder, and a distributed video encoding and decoding method may generate side information through a symmetrical motion prediction, encode and decode only portion, which is significantly distorted in the side information, through an evaluation of the side information, and thereby may relatively simplify a decoder.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a distributed video encoder and a distributed video decoder according to an embodiment of the present invention;

FIGS. 2, 3, and 4 are diagrams illustrating examples to describe a method of generating side video information using a video interpolation scheme according to an embodiment of the present invention;

FIG. 5 is a flowchart illustrating a distributed video encoding method according to an embodiment of the present invention; and

FIG. 6 is a flowchart illustrating a distributed video decoding method according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

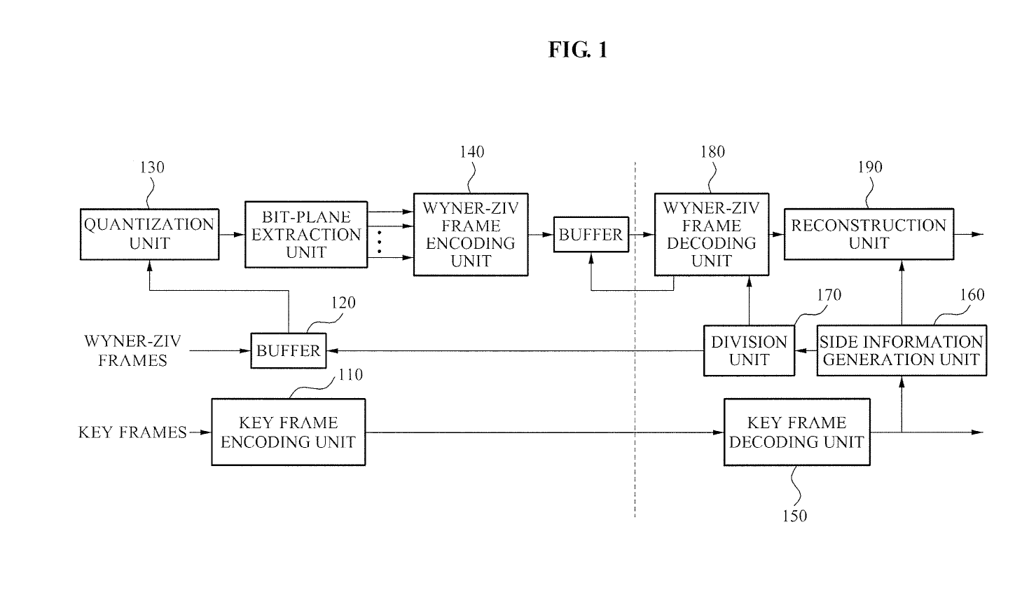

FIG. 1 is a block diagram illustrating a configuration of a distributed video encoder and a distributed video decoder according to an embodiment of the present invention. Referring to FIG. 1, the configuration of the distributed video encoder and the distributed video decoder is described.

The distributed video encoder may include a key frame encoding unit 110, a buffer 120, a quantization unit 130, and a Wyner-Ziv frame encoding unit 140.

The key frame encoding unit 110 may encode a key frame of a video and provide the encoded key frame to a distributed video decoder. The video, provided to the distributed video decoder, may include the key frame and a Wyner-Ziv frame.

In this instance, the key frame encoding unit 110 may perform encoding using an H.264 intra frame coding scheme which is one of a number of video coding schemes.

The buffer 120 may receive first channel video information, which is distorted by more than a predetermined value, in response to the provided key frame.

In this instance, the first channel video may be separated from side video information generated by applying a video interpolation scheme to the key frames. Also, the first channel video may include blocks having a confidence less than a predetermined value.

The quantization unit 130 may quantize the Wyner-Ziv frame using the first channel video information.

The Wyner-Ziv frame encoding unit 140 may encode the quantized Wyner-Ziv frame.

The distributed video decoder may include a key frame decoding unit 150, a side information generation unit 160, and a division unit 170. The distributed video decoder may further include a Wyner-Ziv frame decoding unit 180 and a reconstruction unit 190.

The key frame decoding unit 150 may receive and decode an encoded key frame. In this instance, the key frame may be extracted from an input video. The key frame decoding unit 150 may perform decoding using an H.264 intra frame coding scheme which is one of hybrid video coding schemes.

The side information generation unit 160 may generate side video information by applying the video interpolation scheme to the key frames. The side video information may be used to encode the Wyner-Ziv frame.

The division unit 170 may divide the side video information into first channel video information and second channel video information, and provide the divided first channel video information to the distributed video encoder. The first channel video information may be distorted by more than a predetermined value, and the second channel video information may be distorted by less than the predetermined value.

In this instance, the first channel video information may include blocks having a confidence less than the predetermined value, and the second channel video information may include blocks having a confidence greater than the predetermined value.

The Wyner-Ziv frame decoding unit 180 may decode the Wyner-Ziv frame, encoded using the first channel video information, using the second channel video information.

The reconstruction unit 190 may reconstruct the decoded Wyner-Ziv frame using the side video information.

The distributed video encoder and the distributed video decoder may be operated as described below.

The key frame encoding unit 110 of the distributed video encoder may encode the key frame of the video and provide the encoded key frame to the distributed video decoder.

The key frame decoding unit 150 of the distributed video decoder may receive and decode the encoded key frame.

The side information generation unit 160 of the distributed video decoder may generate the side video information, used to encode the Wyner-Ziv frame, by applying the video interpolation scheme to the key frames.

The division unit 170 of the distributed video decoder may divide the side video information into the first channel video information and the second channel video information, and provide the first channel video information to the distributed video encoder.

The buffer 120 of the distributed video encoder may receive the first channel video information, which is distorted by more than the predetermined value, in response to the provided key frame.

The quantization unit 130 of the distributed video encoder may quantize the Wyner-Ziv frame using the first channel video information.

The Wyner-Ziv frame encoding unit 140 of the distributed video encoder may encode the quantized Wyner-Ziv frame, and provide the encoded Wyner-Ziv frame to the distributed video decoder.

The Wyner-Ziv frame decoding unit 180 of the distributed video decoder may decode the Wyner-Ziv frame, encoded using the first channel video information, using the second channel video information.

In this instance, the second channel video information, received by the Wyner-Ziv frame decoding unit 180, may be received from the division unit 170.

The reconstruction unit 190 of the distributed video decoder may reconstruct the decoded Wyner-Ziv frame using the side video information. In this instance, the reconstruction unit 190 may receive the side video information from the side information generation unit 160.

Accordingly, the side video information may be generated through a symmetrical motion prediction, and only a portion, which is significantly distorted in the side video information, may be encoded and decoded into a channel code through an evaluation of the side video information. Accordingly, the configuration of the distributed video decoder may be relatively simplified.

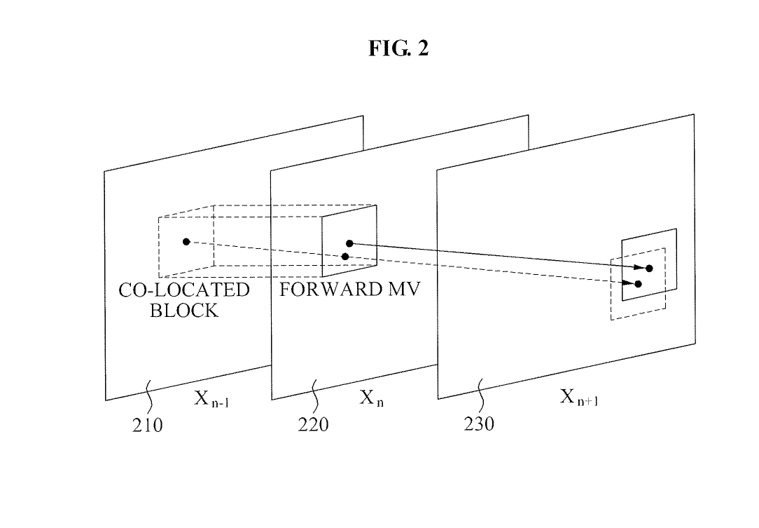

FIGS. 2, 3, and 4 are diagrams illustrating examples to describe a method of generating side video information using a video interpolation scheme according to an embodiment of the present invention.

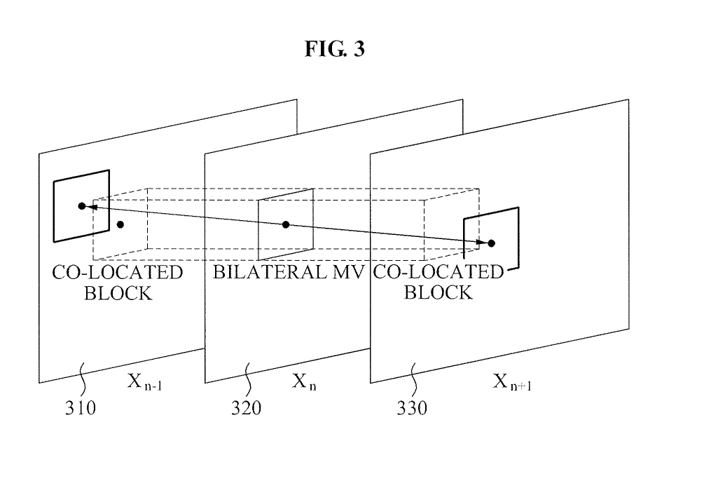

Two methods illustrated in FIGS. 2 and 3 are widely used as an interpolation scheme for generation of side video information.

As illustrated in FIG. 2, one of the two methods may retrieve a block, most similar to a co-located block in an Xₙ₋₁, frame 210, from an Xₙ₊₁ frame 230 to form a block of an Xₙ frame 220, and thereby may select a block being parallel to a vector.

As illustrated in FIG. 3, the other method may select a block, corresponding to each of a block of an Xₙ₋₁ frame 310 and a block of an Xₙ₊₁ frame 330, as a block of an Xₙ 320 frame which is to be restored.

However, since the method of FIG. 2 uses a parallel vector, an actually restored block, that is, the block of the Xₙ₋₁ frame 210 may not be evaluated.

Also, although the method of FIG. 3 may evaluate the block of the Xₙ₋₁ frame 310, the method may minimize energy of two blocks within an operation range. Accordingly, an error that selects an inappropriate block may be generated.

According to an embodiment of the present invention, a symmetrical motion vector may be obtained to overcome the above-described disadvantages of the two methods according to Equation 1 given as below.

$$\begin{matrix}\begin{matrix}v *= arg {min}_{v} [ S A {D}_{f} ( v ) + S A {D}_{b} ( v ) ] , \\ S A {D}_{f} = {\sum }_{p ∈ M} \vert {X}_{n - 1} ( p ) - {X}_{n + 1} ( p + v ) \vert ,\end{matrix} \\ S A {D}_{b} = {\sum }_{p ∈ M} \vert {X}_{n + 1} ( p ) - {X}_{n - 1} ( p - v ) \vert ,\end{matrix} \qquad [ Equation 1 ]$$

where p may denote pixel coordinates of a block M, and a symmetrical motion vector v that may minimize each Sum of Absolute Differences (SAD) is minimized may be selected. The obtained motion vector may be improved as a vector where an SAD of forward and backward frames is minimized frames within a range of [−2, 2]×[−2, 2] to generate side video information with less distortion.

An inappropriate motion vector may be corrected using a Weighted Vector Median Filter (WVMF). Final side video information may be restored according to Equation 2.

$${\hat{X}}_{n} ( p ) = \frac{{X}_{n - 1} ( p - v / 2 ) + {X}_{n + 1} ( p + v / 2 )}{2} \qquad [ Equation 2 ]$$

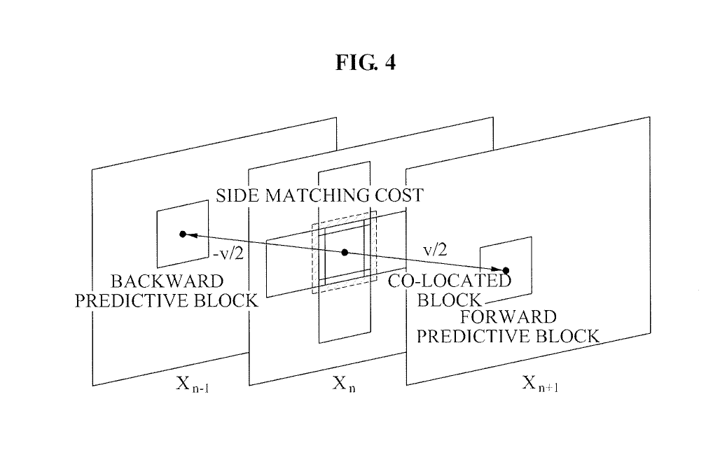

The generated side video information may be divided by a predictor for motion confidence as illustrated in FIG. 4.

A weighted sum of a difference C_{bilateral} of a block located at the positions of two symmetrical motion vectors and a difference C_{side} of a region where the restored block and a side video information block, adjacent to the restored block, are overlapped may be calculated by,

$${C}_{bilateral} = {\sum }_{p ∈ M} \vert \frac{{X}_{n - 1} ( p - v / 2 ) - {X}_{n + 1} ( p + v / 2 )}{2} \vert , \\ {C}_{side} = {\sum }_{p in B} \vert \hat{X} ( p ) - \hat{X} ( n ( p ) ) \vert , \\ C = α \cdot {C}_{bilateral} + ( 1 - α ) \cdot {C}_{side} . \qquad [ Equation 3 ]$$

Side video information may be divided into two groups by a division unit 170 of a distributed video decoder based an evaluation predictor C calculated according to Equation 3. Here, the two groups may include a group of blocks having a high confidence and another group of blocks having a low confidence. According to an embodiment of the present invention, the block having the low confidence may be recognized as a channel with an in an unsuitable transmission environment, and information only about the block may be encoded and decoded. Accordingly, an amount of information to be decoded and encoded may be reduced by half, and an operation complexity of a channel code may be reduced.

Also, according to an embodiment of the present invention, a video quality of side video information may be improved, a transmission bit rate may be reduced, and thus a performance associated with total bit rate-distortion may be improved.

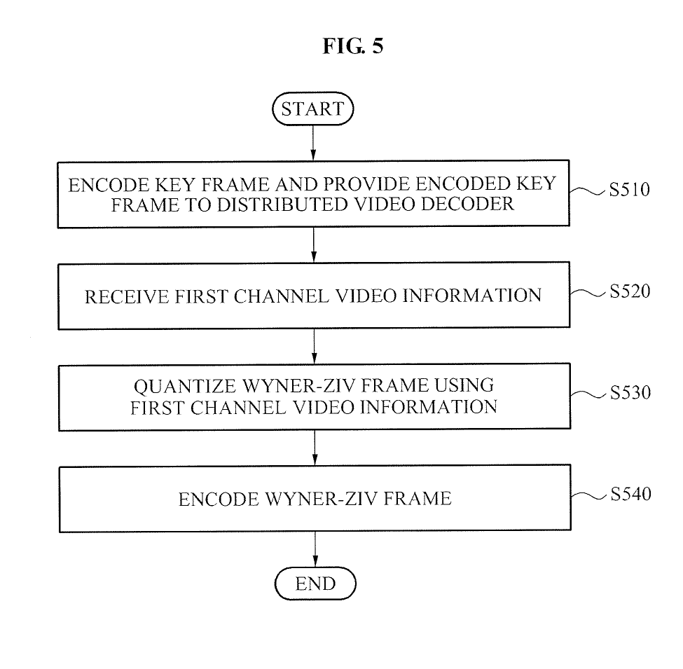

FIG. 5 is a flowchart illustrating a distributed video encoding method according to an embodiment of the present invention. Referring to FIG. 5, the distributed video encoding method is described.

In operation S510, a key frame encoding unit may encode a key frame of a video and provide the encoded key frame to a distributed video decoder. In this instance, the video, inputted to a distributed video encoder, may include the key frame and a Wyner-Ziv frame. The key frame encoding unit may receive the key frame to perform encoding.

The key frame encoding unit may perform encoding using an H.264 intra frame coding scheme which is one of video coding schemes.

In operation S520, a buffer may receive first channel video information, which is distorted by more than a predetermined value, in response to the provided key frame.

In this instance, the first channel video may be divided from side video information generated by applying a video interpolation scheme to the key frames. Also, the first channel video may include blocks having a confidence less than a predetermined value.

In operation S530, a quantization unit may quantize the Wyner-Ziv frame using the first channel video information.

In operation S540, a Wyner-Ziv frame encoding unit may encode the quantized Wyner-Ziv frame.

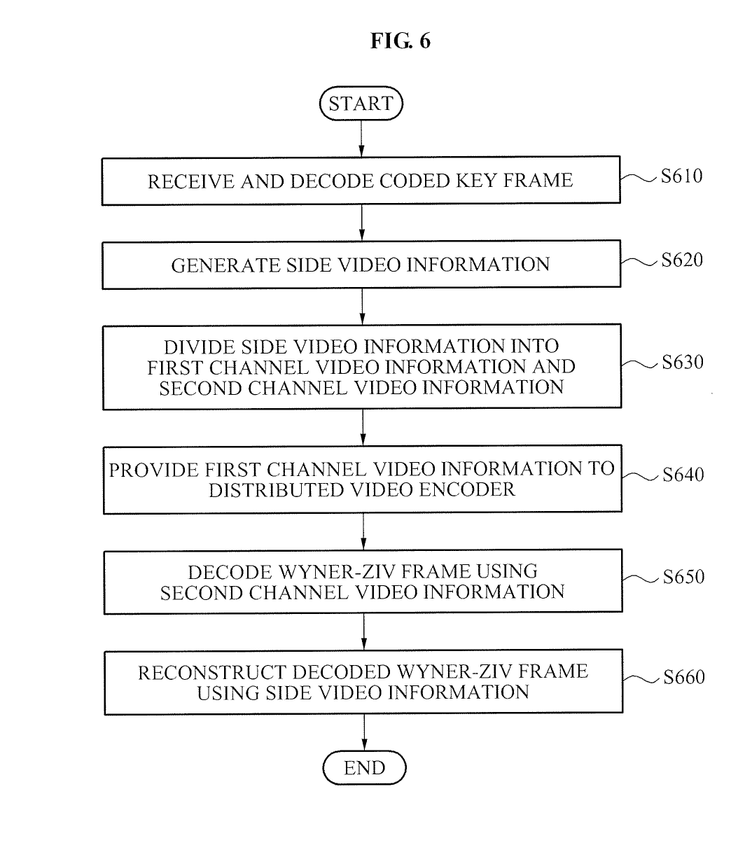

FIG. 6 is a flowchart illustrating a distributed video decoding method according to an embodiment of the present invention. Referring to FIG. 6, the distributed video decoding method is described.

In operation S610, a key frame decoding unit may receive and decode an encoded key frame. In this instance, the key frame may be extracted from an input video. The key frame decoding unit may perform decoding using an H.264 intra frame coding scheme which is one of hybrid video coding schemes.

In operation S620 a side information generation unit may generate side video information by applying a video interpolation scheme to the key frames. The side video information may be used to encode the Wyner-Ziv frame.

In operation S630, a division unit may divide the side video information into first channel video information and second channel video information. The first channel video information may be distorted by more than a predetermined value, and the second channel video information may be distorted by less than the predetermined value. In operation S640, the division unit may provide the divided first channel video information to a distributed video encoder.

In this instance, the first channel video information may include blocks having a confidence less than a predetermined value, and the second channel video information may include blocks having a confidence greater than the predetermined value.

In operation S650, the Wyner-Ziv frame decoding unit may decode the Wyner-Ziv frame, encoded using the first channel video information, using the second channel video information.

In operation S660, a reconstruction unit may reconstruct the decoded Wyner-Ziv frame using the side video information.

According to an embodiment of the present invention, the side video information may be generated through a symmetrical motion prediction, and only a portion, which is significantly distorted in the side video information, may be encoded and decoded through an evaluation of the side video information. Thus, a configuration of the distributed video decoder may be relatively simplified.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A distributed video encoder, comprising:
a key frame encoding unit to encode a key frame of a video and provide the encoded key frame to a distributed video decoder, the video including the key frame and a Wyner-Ziv frame;
a buffer to receive first channel video information, which is distorted by more than a predetermined value, in response to the provided key frame, the first channel video information being divided from side video information generated by applying a video interpolation scheme to the key frames;
a quantization unit to quantize the Wyner-Ziv frame using the first channel video information; and
a Wyner-Ziv frame encoding unit to encode the quantized Wyner-Ziv frame.

2. The distributed video encoder of claim 1, wherein the first channel video information includes blocks having a confidence less than a predetermined value.

3. A distributed video decoder, comprising:
a key frame decoding unit to receive and decode an encoded key frame, the key frame being extracted from an input video;
a side information generation unit to generate side video information used to decode a Wyner-Ziv frame by applying a video interpolation scheme to the key frames; and
a division unit to divide the side video information into first channel video information and second channel video information, and to provide the first channel video information to a distributed video encoder, the first channel video information being distorted by more than a predetermined value, and the second channel video information being distorted by less than the predetermined value.

4. The distributed video decoder of claim 3, further comprising:
a Wyner-Ziv frame decoding unit to decode the Wyner-Ziv frame, encoded using the first channel video information, using the second channel video information.

5. The distributed video decoder of claim 4, further comprising:
a reconstruction unit to reconstruct the decoded Wyner-Ziv frame using the side video information.

6. The distributed video decoder of claim 3, wherein the first channel video information includes blocks having a confidence less than a predetermined value.

7. The distributed video decoder of claim 3, wherein the second channel video information includes blocks having a confidence greater than a predetermined value.

8. A distributed video encoding method, comprising:
extracting a key frame and a Wyner-Ziv frame from an input video;
encoding the key frame and providing the encoded key frame to a distributed video decoder;
receiving first channel video information, which is distorted by more than a predetermined value, in response to the provided key frame, the first channel video information being divided from side video information generated by applying a video interpolation scheme to the key frames;
quantizing the Wyner-Ziv frame using the first channel video information; and
encoding the quantized Wyner-Ziv frame.

9. The distributed video encoding method of claim 8, wherein the first channel video information includes blocks having a confidence less than a predetermined value.

10. A distributed video decoding method, comprising:
receiving and decoding an encoded key frame, the key frame being extracted from an input video;
generating side video information used to decode a Wyner-Ziv frame by applying a video interpolation scheme to the key frames; and
dividing the side video information into first channel video information and second channel video information, and providing the first channel video information to a distributed video encoder, the first channel video information being distorted by more than a predetermined value, and the second channel video information being distorted by less than the predetermined value.

11. The distributed video decoding method of claim 10, further comprising:
decoding the Wyner-Ziv frame, encoded using the first channel video information, using the second channel video information.

12. The distributed video decoding method of claim 11, further comprising:
reconstructing the decoded Wyner-Ziv frame using the side video information.

13. The distributed video decoding method of claim 10, wherein the first channel video information includes blocks having a confidence less than a predetermined value.

14. The distributed video decoding method of claim 10, wherein the second channel video information includes blocks having a confidence greater than a predetermined value.
